(19) United States
(12) Patent Application Publication
(10) Pub. No.: US 2015/0235117 A1
(43) Pub. Date: Aug. 20, 2015

(54) IMAGE PROCESSING APPARATUS AND IMAGE PROCESSING METHOD

(71) Applicant: CANON KABUSHIKI KAISHA, Tokyo (JP)

(72) Inventor: Kaori Nishiyama, Tokyo (JP)

(21) Appl. No.: 14/618,542

(22) Filed: Feb. 10, 2015

(30) Foreign Application Priority Data
Feb. 20, 2014 (JP) 2014-030786

(51) Int. Cl. G06K 15/00

(52) U.S. Cl. CPC G06K 15/4095

(57) ABSTRACT

Whether to limit display of information relating to a job of a type of interest, which belongs to a user other than a login user, is set on a job type basis. Display of the information relating to a job of a designated type is controlled based on a setting set for the designated type.

### BACKGROUND OF THE INVENTION

1. Field of the Invention

The present invention relates to a job management technique.

2. Description of the Related Art

An image processing apparatus is often shared by a plurality of users. Some image processing apparatuses capable of displaying the statuses and history of executed jobs display jobs other than those of a login user with masking or prohibit operations such as stop and delete in combination of an authentication function from the viewpoint of security and privacy (Japanese Patent Laid-Open No. 2005-339508).

In the related art, however, if jobs other than those of a login user are displayed with masking in a case where there is a need to do an operation of outputting and filing a result list from the history of jobs transmitted by facsimile, the result list wanted by the user is not output. Hence, the mask setting needs to be canceled, resulting in a problem from the viewpoint of security.

On the other hand, even though the jobs other than those of the login user are not displayed with masking, and operations such as stop and delete are prohibited, the jobs of the login user and those of other users are displayed while being mixed up together. Hence, the login user cannot immediately find his/her jobs.

### SUMMARY OF THE INVENTION

The present invention has been made in consideration of the above-described problems, and provides a technique of controlling display of information relating to a job of a non-login user on a job type basis. The present invention also provides a technique of controlling an operation for a job of a non-login user on a job type basis.

According to the first aspect of the present invention, there is provided an image processing apparatus comprising: a setting unit configured to set on a job type basis whether to limit display of information relating to a job of a type of interest, which belongs to a user other than a login user; and a control unit configured to control the display of the information relating to a job of a designated type based on a setting set by the setting unit for the designated type.

According to the second aspect of the present invention, there is provided an image processing method performed by an image processing apparatus, comprising: a setting step of setting on a job type basis whether to limit display of information relating to a job of a type of interest, which belongs to a user other than a login user; and a control step of controlling the display of the information relating to a job of a designated type based on a setting set in the setting step for the designated type.

Further features of the present invention will become apparent from the following description of exemplary embodiments (with reference to the attached drawings).

### BRIEF DESCRIPTION OF THE DRAWINGS

FIG. 1 is a block diagram showing an example of the hardware arrangement of an image processing apparatus 100;

FIG. 2 is a view showing a display example of a GUI;

FIG. 3 is a view showing a display example of a GUI;

FIG. 4 is a flowchart of a process performed by the image processing apparatus 100;

FIG. 5 is a view showing an example of a list;

FIG. 6 is a flowchart of a process performed by the image processing apparatus 100;

FIG. 7 is a view showing a display example of a GUI; and

FIG. 8 is a block diagram showing an example of the functional arrangement of the image processing apparatus 100.

### DESCRIPTION OF THE EMBODIMENTS

The embodiments of the present invention will now be described with reference to the accompanying drawings. Note that the embodiments to be described below are examples of detailed implementation of the present invention or detailed examples of the arrangement described in the appended claims.

### First Embodiment

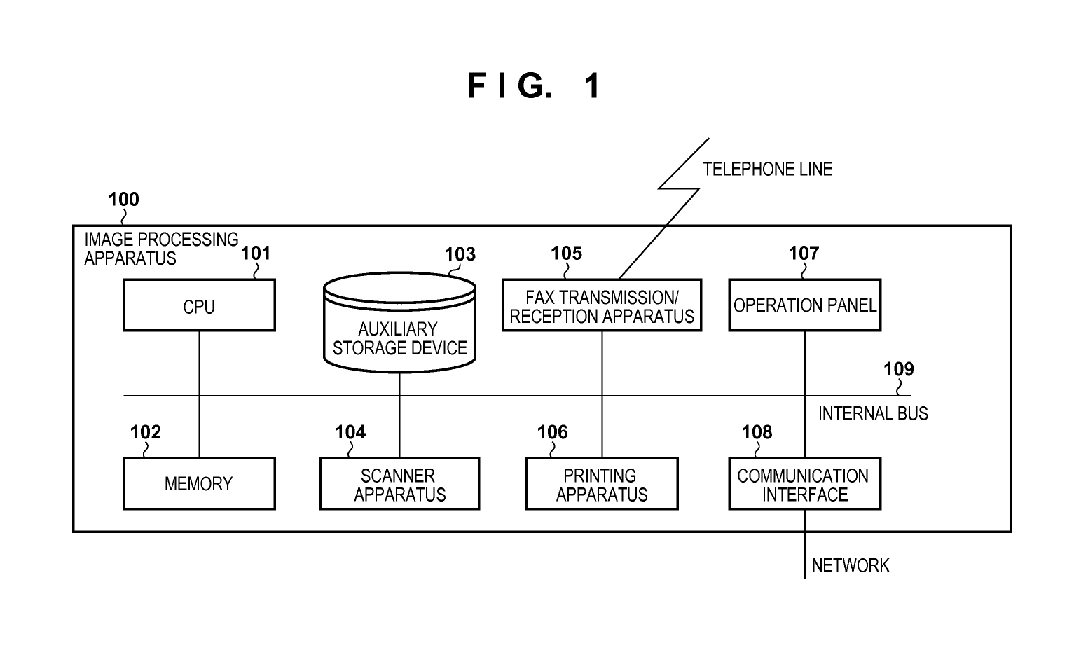

An example of the hardware arrangement of an image processing apparatus 100 according to this embodiment will be described first with reference to the block diagram of FIG. 1. Note that the arrangement shown in FIG. 1 is merely an example, and is not intended to limit the scope of the present invention. That is, any other arrangement can be employed as long as it can execute processes to be described below.

A CPU 101 controls the operation of the entire apparatus by executing processes using computer programs and data stored in a memory 102, and also executes processes to be described later as processes to be executed by the image processing apparatus 100.

The memory 102 includes an area to temporarily store computer programs and data loaded from an auxiliary storage device 103. The memory 102 also includes an area to temporarily store data of an image read by a scanner apparatus 104, fax data received by a FAX transmission/reception apparatus 105, or data externally received via a communication interface 108. The memory 102 also includes a work area used by the CPU 101 to execute various processes. That is, the memory 102 can appropriately offer various areas.

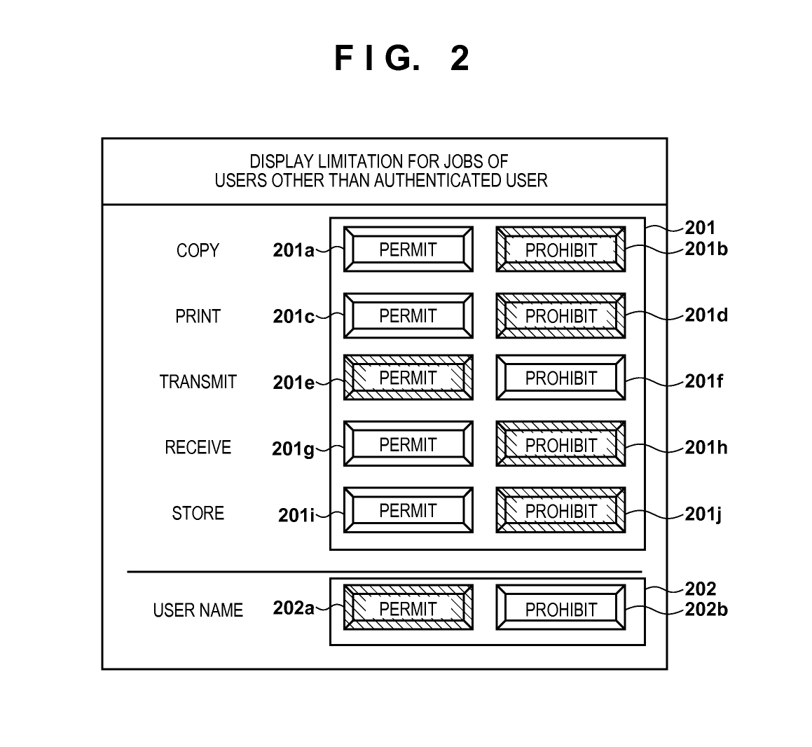

The auxiliary storage device 103 is a mass storage represented by a hard disk drive. The auxiliary storage device 103 stores the OS (Operating System) and computer programs and data used to cause the CPU 101 to execute processes to be described later as processes to be executed by the image processing apparatus 100. The computer programs include the computer programs of GUIs (Graphical User Interfaces) as shown in FIGS. 2, 3, and 7.

The computer programs and data stored in the auxiliary storage device 103 are appropriately loaded to the memory 102 under the control of the CPU 101 and processed by the CPU 101.

The scanner apparatus 104 reads information printed on a print medium such as paper as an image and outputs the read image, as is known. The FAX transmission/reception apparatus 105 transmits data in the apparatus as fax data, or receives fax data transmitted from an external device.

A printing apparatus 106 prints an image or characters on a print medium such as paper based on print data, as is known. An operation panel 107 includes a touch panel type screen (touch panel screen) and hard keys.

The communication interface 108 transmits data to an external device via a network, and transmits/receives, for example, e-mail, SMB, and information necessary for the device. All components described above are connected to an internal bus 109.

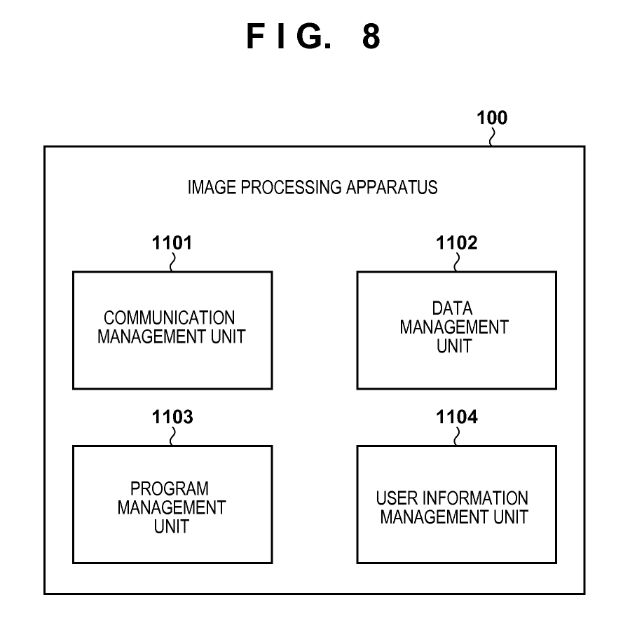

An example of the functional arrangement of the image processing apparatus 100 will be described with reference to the block diagram of FIG. 8. A communication management unit 1101 analyzes a communication command exchanged via the communication interface 108 or controls communication. A data management unit 1102 manages various data handled by the image processing apparatus 100. A program management unit 1103 controls and manages execution of resident or non-resident programs managed by the data management unit 1102. A user information management unit 1104 manages information necessary for user authentication queried by the program management unit 1103.

The operation of the image processing apparatus 100 will be described next. First, using the image processing apparatus 100, a specific user such as a system administrator (to be referred to as a specific user hereinafter) sets, on a job type basis, whether to apply masking when displaying information relating to jobs of a type of interest, which belong to non-login users other than the login user.

FIG. 2 shows a display example of a GUI for this setting. For example, the specific user inputs his/her user ID and password (to be referred to as authentication information hereinafter) and inputs an authentication start instruction (login instruction) by operating hard keys or buttons displayed on the touch panel screen. The CPU 101 performs an authentication process using the input authentication information, and if the authentication (login) has succeeded, displays the GUI shown in FIG. 2 on the touch panel screen.

Buttons are displayed in a region 201, which are used, when displaying information relating to a job corresponding to items “copy”, “print”, “transmit”, “receive”, and “store”, to set whether to display the information with masking if the job belongs to a non-login user.

On the touch panel screen, the user can select (touch) only one of a “permit” button 201a and a “prohibit” button 201b corresponding to the item “copy”. When the user selects the “permit” button 201a on the touch panel screen, setting is done so as to display information relating to a “copy” job (job that requests the scanner apparatus 104 and the printing apparatus 106 to do copy) of each non-login user without masking. When the user selects the “prohibit” button 201b on the touch panel screen, setting is done so as to display information relating to a “copy” job of each non-login user with masking.

On the touch panel screen, the user can select (touch) only one of a “permit” button 201c and a “prohibit” button 201d corresponding to the item “print”. When the user selects the “permit” button 201c on the touch panel screen, setting is done so as to display information relating to a “print” job (job that requests the printing apparatus 106 to print) of each non-login user without masking. When the user selects the “prohibit” button 201d on the touch panel screen, setting is done so as to display information relating to a “print” job of each non-login user with masking.

On the touch panel screen, the user can select (touch) only one of a “permit” button 201e and a “prohibit” button 201f corresponding to the item “transmit”. When the user selects the “permit” button 201e on the touch panel screen, setting is done so as to display information relating to a “transmit” job (job that requests the FAX transmission/reception apparatus 105 or the communication interface 108 to do transmission) of each non-login user without masking. When the user selects the “prohibit” button 201f on the touch panel screen, setting is done so as to display information relating to a “transmit” job of each non-login user with masking.

On the touch panel screen, the user can select (touch) only one of a “permit” button 201g and a “prohibit” button 201h corresponding to the item “receive”. When the user selects the “permit” button 201g on the touch panel screen, setting is done so as to display information relating to a “receive” job (job that requests the FAX transmission/reception apparatus 105 or the communication interface 108 to do reception) of each non-login user without masking. When the user selects the “prohibit” button 201h on the touch panel screen, setting is done so as to display information relating to a “receive” job of each non-login user with masking.

On the touch panel screen, the user can select (touch) only one of a “permit” button 201i and a “prohibit” button 201j corresponding to the item “store”. When the user selects the “permit” button 201i on the touch panel screen, setting is done so as to display information relating to a “store” job (job that requests the CPU 101 to store data) of each non-login user without masking. When the user selects the “prohibit” button 201j on the touch panel screen, setting is done so as to display information relating to a “store” job of each non-login user with masking.

FIG. 2 illustrates a state in which setting is done so as to display information relating to “transmit” jobs of non-login users without masking, and display information relating to jobs of non-login users with masking concerning any type other than “transmit”.

Buttons 202a and 202b used to set whether to display the user names of non-login users with masking are displayed in a region 202. The user can select (touch) only one of the “permit” button 202a and the “prohibit” button 202b on the touch panel screen. When the user selects the “permit” button 202a on the touch panel screen, setting is done so as to display the user name of each non-login user without masking. When the user selects the “prohibit” button 202b on the touch panel screen, setting is done so as to display the user name of each non-login user with masking.

When the user makes the setting using the GUI shown in FIG. 2 and then performs an operation of instructing to complete the setting using the operation panel 107, the CPU 101 registers information representing the setting set using the GUI shown in FIG. 2 in the auxiliary storage device 103 as setting information.

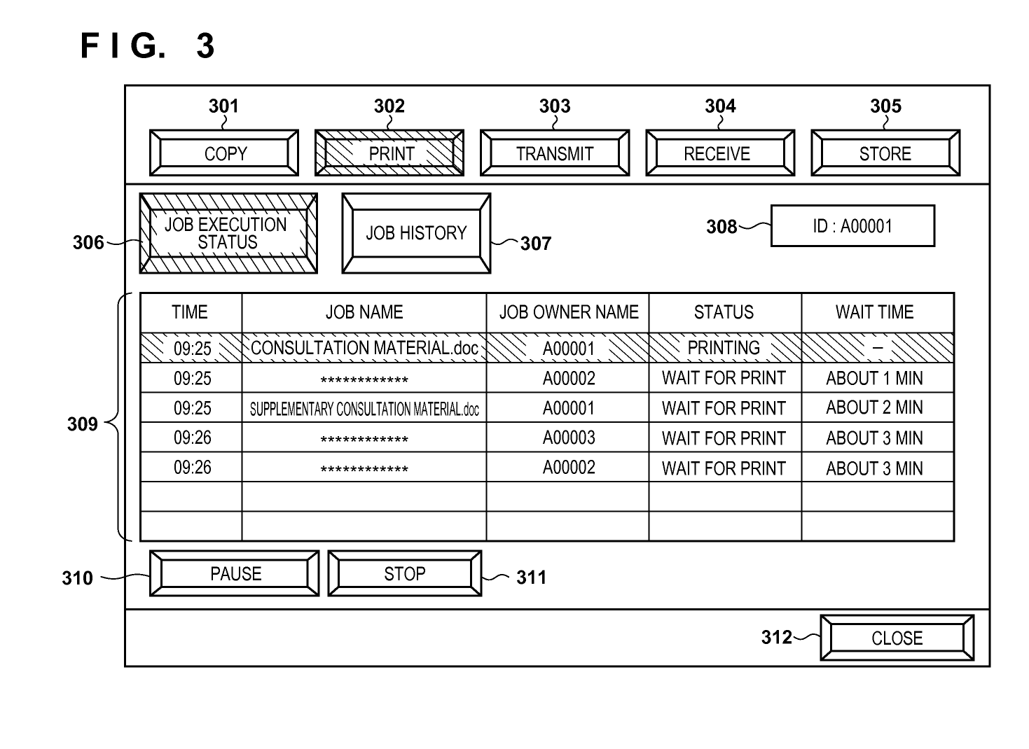

Assume that after that, a certain user inputs his/her authentication information and inputs an authentication start instruction by operating hard keys or buttons displayed on the touch panel screen, and the CPU 101 performs an authentication process using the input authentication information and succeeds in the authentication. At this time, the CPU 101 displays a GUI shown in FIG. 3 on the touch panel screen.

In this embodiment, “information relating to a job” displayed on the GUI shown in FIG. 3 is assumed to include a job input time, a job name, a job owner name (user name (=user ID) included in a job), a job status (currently processed or process wait), and a wait time (in case of a process wait job). However, the present invention is not limited to this.

A button 301 is used to input an instruction to display information relating to “copy” jobs as a list 309. A button 302 is used to input an instruction to display information relating to “print” jobs as the list 309. A button 303 is used to input an instruction to display information relating to “transmit” jobs as the list 309. A button 304 is used to input an instruction to display information relating to “receive” jobs as the list 309. A button 305 is used to input an instruction to display information relating to “store” jobs as the list 309. That is, the buttons 301 to 305 are used to designate a job type whose information is displayed in a list format.

A button 306 is used to input an instruction to display information relating to, out of jobs of a type corresponding to a selected one of the buttons 301 to 305, jobs currently processed and process wait jobs as the list 309.

A button 307 is used to input an instruction to display information relating to, out of jobs of a type corresponding to a selected one of the buttons 301 to 305, processed jobs as the list 309.

In FIG. 3, since the button 302 out of the buttons 301 to 305 is selected, and the button 306 out of the buttons 306 and 307 is selected, designation is made to display a list of information relating to “print” jobs currently processed and process wait “print” jobs.

The GUI shown in FIG. 3 corresponds to the setting information set by the GUI shown in FIG. 2. In the GUI shown in FIG. 2, setting is done so as to display information relating to a “print” job of each non-login user with masking. Hence, as shown in FIG. 3, pieces of information relating to “print” jobs of the login user, that is, the user having user ID=A00001 are directly displayed without masking. On the other hand, pieces of information (job names in FIG. 3) relating to “print” jobs of non-login users, that is, users having user IDs other than user ID=A00001 are displayed with masking. In FIG. 3, “display with masking” means displaying a character string of “*” in place of an original character string. However, any other display method may be employed. A user ID input by the login user at the time of login is displayed in a region 308.

A button 310 is used to pause execution of a job designated by the user out of the jobs displayed in the list 309. A button 311 is used to stop execution of a job designated by the user out of the jobs displayed in the list 309.

In this embodiment, an operation for a job as a masking display target, that is, a job of a non-login user is prohibited. The operation means stopping execution of a job, changing the attribute of a job, or confirming detailed information of a job, or the like. For example, when the user selects a job corresponding to user ID=A00002 in the list 309 during a process of the job, selecting the button 310 or 311 is prohibited (for example, the buttons are shaded to disable press). A button 312 is used to close the GUI shown in FIG. 3.

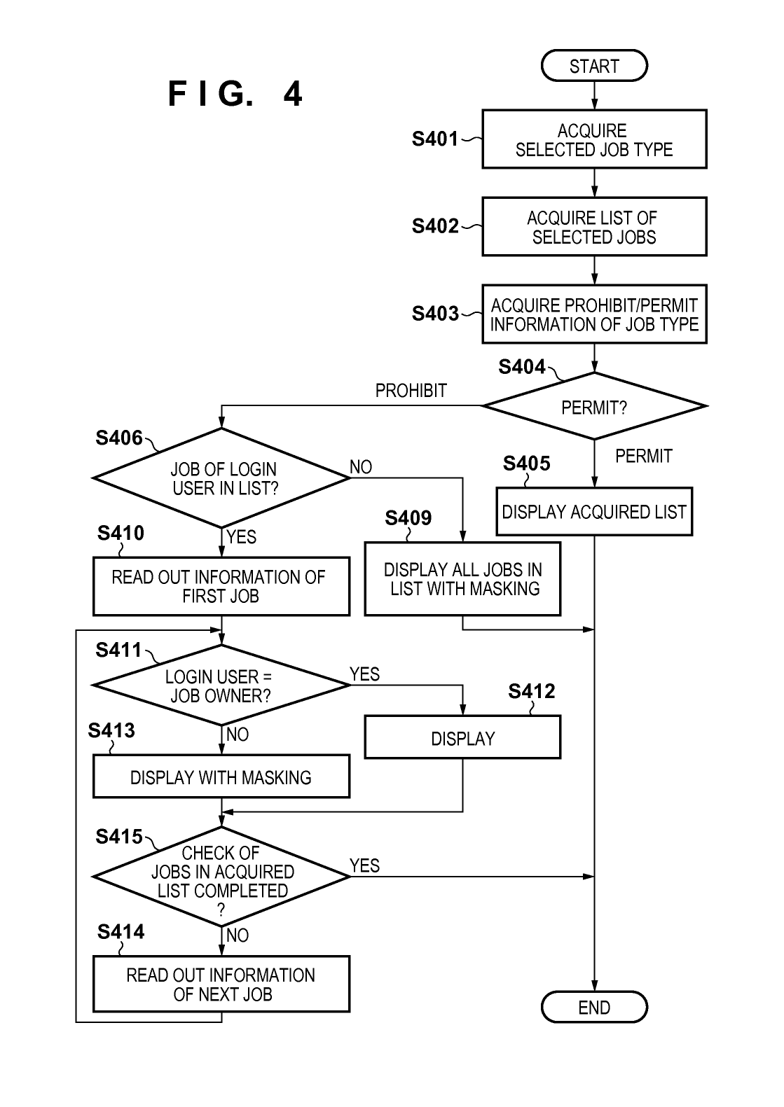

A process performed by the image processing apparatus 100 in a state in which the user designates the button 306 will be described next with reference to the flowchart of FIG. 4. FIG. 4 is a flowchart for explaining the operation of the image processing apparatus 100 when displaying a job status screen. Note that setting by the buttons 202a and 202b is not taken into consideration below for the descriptive convenience.

Note that a computer program and data used to cause the CPU 101 to execute the process according to the flowchart of FIG. 4 are stored in the auxiliary storage device 103. Hence, the CPU 101 executes the process according to the flowchart of FIG. 4 by loading the computer program and data to the memory 102 and executing the process using the loaded computer program and data.

In step S401, a selected one of the buttons 301 to 305 is determined, thereby specifying the job type corresponding to the selected button. In the case of FIG. 3, since the button 302 is selected, it is specified that “print” is designated as the job type.

In step S402, the list of information relating to jobs of the type (to be referred to as a type X hereinafter) specified in step S401 out of the information relating to jobs currently processed or process wait jobs managed in the memory 102 or the auxiliary storage device 103 is acquired. In the case of FIG. 3, the CPU acquires the list of information relating to “print” jobs out of the jobs currently processed or process wait jobs.

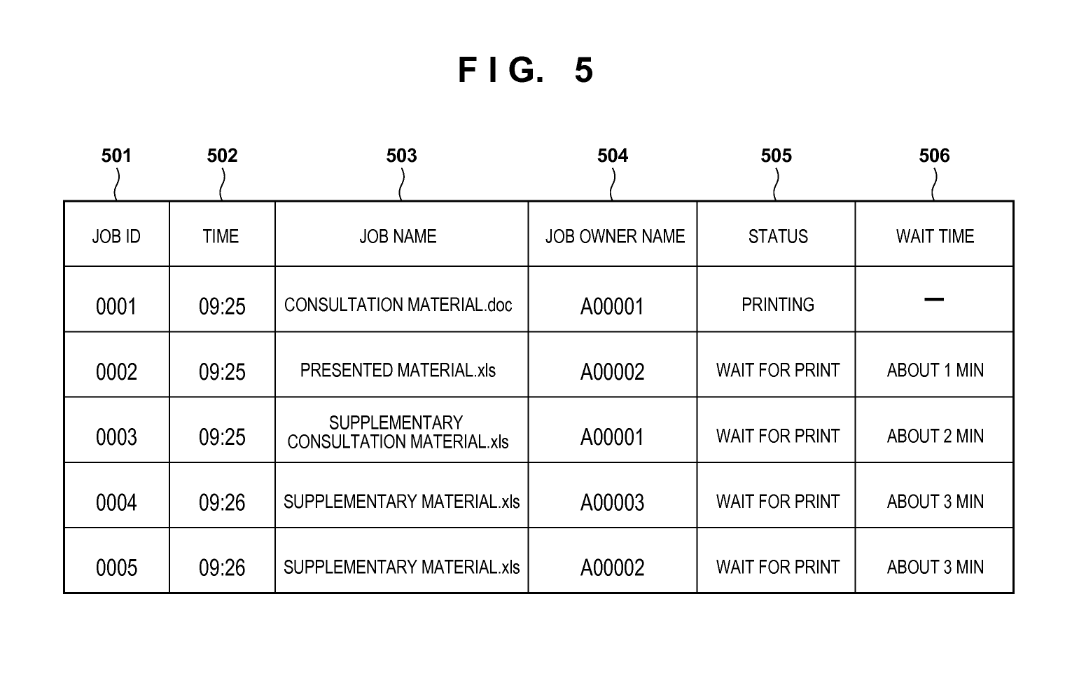

FIG. 5 shows an example of the list acquired in step S402. FIG. 5 illustrates an example of a list of information relating to “print” jobs out of the jobs currently processed or process wait jobs. A job ID 501 is an ID unique to a job, a time 502 is the input time of a job, a job name 503 is the name of a job, a job owner name 504 is the user name (=user ID) of a job, a status 505 is information representing whether a job is a job currently processed or a process wait job. A wait time 506 is the wait time of a process wait job.

Note that information relating to a job also includes the following information in addition to those shown in FIG. 5. For example, information relating to a copy job includes the number of printed sheets, number of copies, file name, time (output time) necessary for output, wait time, and the like. A department ID, file name, and the like are also included in the information relating to the job.

Information relating to a print job includes the number of rasterized pages, reception data size, output time, wait time, number of printed sheets, and the like. Information relating to a transmission job includes a destination name, destination, transmission mode, transmission file name, number of transmitted pages, and the like.

Information relating to a reception job includes a source address, reception time, receipt number, and communication mode, and when transferring received data, also includes a transfer destination, number of received pages, and the like. Information relating to a storage job includes a storage destination, stored file name, number of stored pages, and the like.

In step S403, out of settings set on a job type basis using the GUI shown in FIG. 2, a setting corresponding to the type X is acquired. In the case of FIG. 3, the setting set for “print” jobs by the GUI shown in FIG. 2 is acquired.

In step S404, it is determined whether the setting acquired in step S403 is “permit” (display without masking: unlimited) or “prohibit” (display with masking: limited). Upon determining that the setting is “permit”, the process advances to step S405. If the setting is “prohibit”, the process advances to step S406. In the case of FIGS. 2 and 3, since “display information relating to “print” jobs of non-login users with masking” is set for “print” jobs, the process advances to step S406.

In step S405, each information registered in the list acquired in step S402 is displayed on the touch panel screen without masking.

On the other hand, in step S406, the list acquired in step S402 is searched for the user ID of the login user. If the user ID of the login user is found as the result of search, the process advances to step S410. If the user ID is not found, the process advances to step S409.

In step S409, it is determined that the list includes no information relating to jobs of type X of the login user (includes only jobs of type X of non-login users). Then, each information registered in the list acquired in step S402 is displayed on the touch panel screen. Part of the information (in FIG. 3, “job name”) is displayed with masking.

In step S410, information relating to the first job is read out from the information relating to jobs registered in the list acquired in step S402. In the case of FIG. 5, information relating to a job corresponding to job ID=0001 is read out.

In step S411, it is determined whether the user ID in the information read out in step S410 matches the user ID of the login user. Upon determining that the user IDs match, the process advances to step S412. If they do not match, the process advances to step S413.

In step S412, the information read out in step S410 is information relating to a job of type X of the login user and is therefore displayed on the touch panel screen without masking.

On the other hand, in step S413, the information read out in step S410 is information relating to a job of type X of a non-login user and is therefore displayed on the touch panel screen with masking on part of the information (in FIG. 3, “job name”).

In the case of FIG. 3, since the user ID of the login user is A00001, all pieces of information relating to jobs corresponding to job owner name=A00001 are displayed without masking. On the other hand, as for information relating to jobs corresponding to job owner names other than A00001, the pieces of information of the time, job owner name, job status, and wait time are displayed without masking, and the job name is displayed with masking.

In step S415, it is determined whether the pieces of information relating to all jobs in the list acquired in step S402 are read out. Upon determining that the pieces of information relating to all jobs are read out, the process according to the flowchart of FIG. 4 ends. If yet-to-be-read information relating to a job remains, the process advances to step S414.

In step S414, yet-to-be-read information relating to a job is read out from the list acquired in step S402, and the process returns to step S411. In the case of FIG. 5, when the above process is performed for the jobs having job IDs=0001 to 0005, all pieces of information relating to jobs corresponding to job owner name=A00001 are displayed without masking, as shown in FIG. 3. Out of the information relating to jobs (jobs of non-login users) corresponding to job owner names other than A00001, job names are displayed with masking.

Note that after the process according to the flowchart of FIG. 4, pieces of identification information (job ID or the like) of jobs (target jobs) as the masking display target in steps S409 and S413 are, for example, recorded in the auxiliary storage device 103, thereby recording the information to specify the target jobs in the auxiliary storage device 103. After that, if a job selected in the list 309 by the user is a target job, that is, a job corresponding to the identification information, selecting the button 310 or 311 is prohibited (for example, the buttons are shaded to disable press).

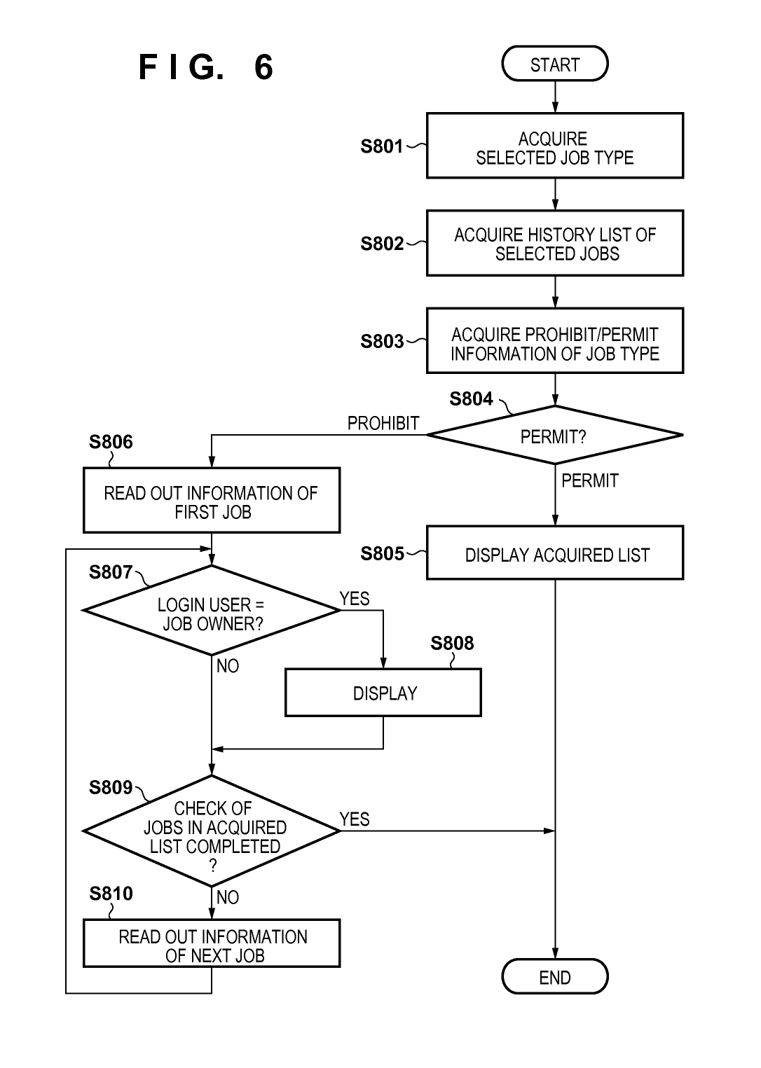

A process performed by the image processing apparatus 100 in a state in which the user designates the button 307 will be described next with reference to the flowchart of FIG. 6. FIG. 6 is a flowchart for explaining the operation of the image processing apparatus 100 when displaying a job history. Note that a computer program and data used to cause the CPU 101 to execute the process according to the flowchart of FIG. 6 are stored in the auxiliary storage device 103. Hence, the CPU 101 executes the process according to the flowchart of FIG. 6 by loading the computer program and data to the memory 102 and executing the process using the loaded computer program and data.

In step S801, a selected one of the buttons 301 to 305 is determined, thereby specifying the job type corresponding to the selected button, as in step S401 described above.

In step S802, the list of information relating to jobs of the type (to be referred to as a type Y hereinafter) specified in step S801 out of the information relating to processed jobs stored in the memory 102 or the auxiliary storage device 103 is acquired, as in step S402 described above.

Information relating to a processed job includes for example, the following information. For example, information relating to a copy job includes a print date/time, number of printed sheets, number of copies, print result, number of original pages, number of output pages, and the like. Information relating to a print job includes a print date/time, number of printed sheets, file name, print result, and the like. Information relating to a transmission job includes a transmission date/time, destination, transmission result, transmitted file name, number of transmitted pages, transmission data size, communication mode, and the like. Information relating to a reception job includes a reception date/time, source, reception result, number of received pages, transfer destination (when transferring received data), and the like. Information relating to a storage job includes a storage date/time, storage destination folder, stored file name, storage result, number of stored pages, storage data size, and the like.

In step S803, out of settings set on a job type basis using the GUI shown in FIG. 2, a setting corresponding to the type Y is acquired, as in step S403 described above. In step S804, it is determined whether the setting acquired in step S803 is “permit” (display without masking) or “prohibit” (display with masking). Upon determining that the setting is “permit”, the process advances to step S805. If the setting is “prohibit”, the process advances to step S806. In step S805, each information registered in the list acquired in step S802 is displayed on the touch panel screen without masking.

On the other hand, in step S806, information relating to the first job is read out from the information relating to jobs registered in the list acquired in step S802. In step S807, it is determined whether the user ID in the information read out in step S806 matches the user ID of the login user. Upon determining that the user IDs match, the process advances to step S808. If they do not match, the process advances to step S809.

In step S808, the information read out in step S806 is information relating to a job of type Y of the login user and is therefore displayed on the touch panel screen without masking.

On the other hand, in step S809, it is determined whether the pieces of information relating to all jobs in the list acquired in step S802 are read out. Upon determining that the pieces of information relating to all jobs are read out, the process according to the flowchart of FIG. 6 ends. If yet-to-be-read information relating to a job remains, the process advances to step S810. In step S810, yet-to-be-read information relating to a job is read out from the list acquired in step S802, and the process returns to step S807.

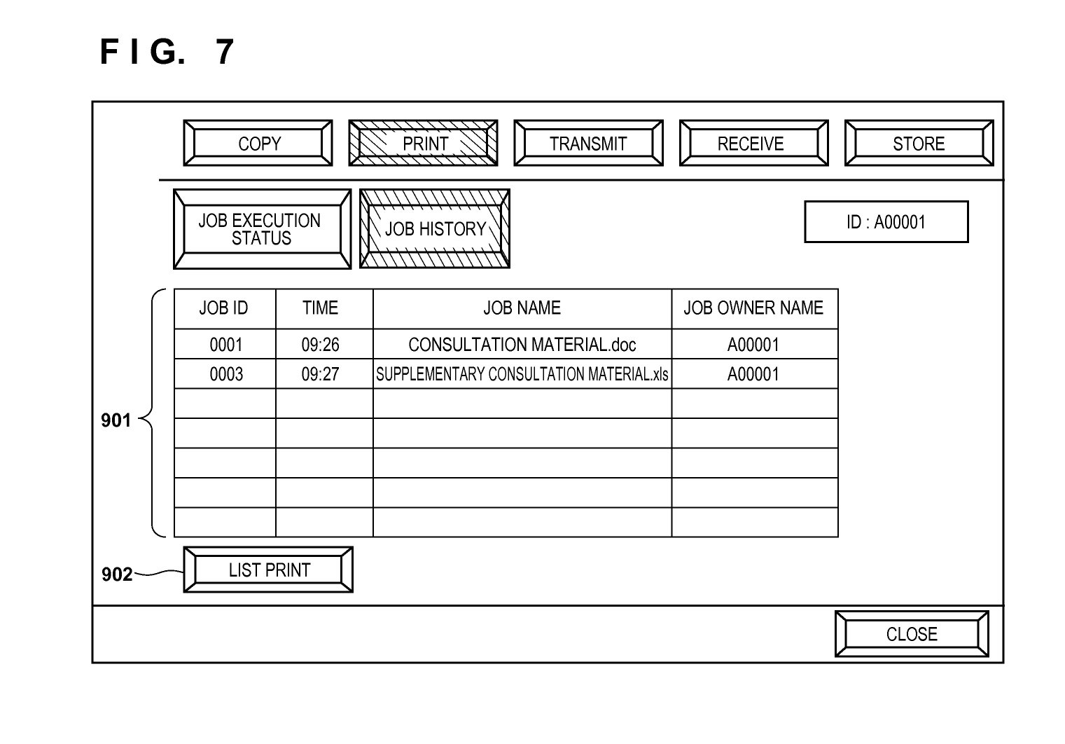

As a result of this process, a GUI shown in FIG. 7 is displayed on the touch panel screen. As shown in FIG. 7, pieces of information as the display targets in step S805 or S808 are displayed as a list 901. A button 902 is used to instruct the printing apparatus 106 to print the screen including the list 901 in an appropriate format.

In this embodiment, the masking target candidate is the job name. However, depending on information to be listed, other information may be selected as the masking target candidate in place of or in addition to the job name.

### Second Embodiment

In the first embodiment, when the button 306 is selected, the process according to the flowchart of FIG. 4 is executed, and when the button 307 is selected, the process according to the flowchart of FIG. 6 is executed, as described above. However, the timings of executing the processes (or modifications thereof) according to the flowcharts of FIGS. 4 and 6 are not limited to these.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-030786, filed Feb. 20, 2014, which is hereby incorporated by reference herein in its entirety.

What is claimed is:

1. An image processing apparatus comprising:
a setting unit configured to set on a job type basis whether to limit display of information relating to a job of a type of interest, which belongs to a user other than a login user; and
a control unit configured to control the display of the information relating to a job of a designated type based on a setting set by said setting unit for the designated type.

2. The apparatus according to claim 1, wherein when the setting set by said setting unit for the designated type is a setting to limit the display of the information relating to the job, said control unit displays information relating to a job currently processed and a process wait job of the designated type, which belong to the user other than the login user, with masking.

3. The apparatus according to claim 2, further comprising a unit configured to prohibit an operation for the job currently processed and the process wait job, which are masked.

4. The apparatus according to claim 3, wherein the operation is an operation of stopping execution of the job.

5. The apparatus according to claim 1, wherein when the setting set by said setting unit for the designated type is a setting to limit the display of the information relating to the job, said control unit does not display information relating to a processed job of the designated type, which belongs to the user other than the login user.

6. An image processing method performed by an image processing apparatus, comprising:
a setting step of setting on a job type basis whether to limit display of information relating to a job of a type of interest, which belongs to a user other than a login user; and
a control step of controlling the display of the information relating to a job of a designated type based on a setting set in the setting step for the designated type.

7. A non-transitory computer-readable storage medium storing a computer program that causes a computer to function as each unit of an image processing apparatus of claim 1.
